(19) United States
(12) Patent Application Publication
(10) Pub. No.: US 2015/0101642 A1
(43) Pub. Date: Apr. 16, 2015

(54) PRODUCE WASHING SYSTEM AND METHODS

(71) Applicant: CFA Properties, Inc., Wilmington, DE (US)

(72) Inventor: C. Harold King, Atlanta, GA (US)

(21) Appl. No.: 14/512,947

(22) Filed: Oct. 13, 2014

Related U.S. Application Data
(60) Provisional application No. 61/889,848, filed on Oct. 11, 2013.

(51) Int. Cl. A23N 12/06

(52) U.S. Cl. CPC A23N 12/06
USPC 134/25.3; 134/95.2; 134/44

(57) ABSTRACT

Systems and methods for washing produce to achieve an approximate 5 log colony-forming unit (CFU) reduction of foodborne pathogens per unit of produce are disclosed. In an example embodiment of the disclosed technology, a method includes rinsing the produce. Further, a method may include cleaning or soaking the produce in a cleaning solution. A method may include draining the cleaning solution to remove organic material. A method may further comprise sanitizing the produce, which may include soaking and/or agitating the produce in a sanitizing solution for a predetermined period of time. Finally, a method may comprise draining any remaining solution and drying the produce to remove solution from the surface of the produce.

### CROSS REFERENCE TO RELATED APPLICATION

This application claims benefit under 35 U.S.C. §119(e) of U.S. Provisional Patent Application Nos. 61/889,848, filed Oct. 11, 2013, entitled “Produce Washing System Using Electrolyzed Water,” which is incorporated herein by reference as if set forth herein in its entirety.

### FIELD OF THE INVENTION

The present disclosure relates to food safety and, more particularly, to a produce washing system that can achieve an approximate 5 log colony-forming unit (CFU) reduction of foodborne pathogens per unit of produce.

### BACKGROUND

Consumption of fresh produce in the United States has increased in recent years as a result of the active promotion of vegetables and fruits as an important part of healthier diets. Concurrent with this increase, the frequency of outbreaks of foodborne illness associated with consumption of contaminated produce has also increased. Further, improving epidemiological systems (such as PulseNet of the Centers for Disease Control and Prevention), which are used to determine the source of foodborne illness outbreaks, have made it easier to pinpoint when contaminated produce leads to an outbreak. These outbreaks have raised public concerns about the safety of produce and caused economic losses in the produce and food retail industries.

Salmonella and Escherichia coli O157:H7 have proven to be most problematic in fresh produce, with these two bacterial pathogens having been respectively responsible for about 50% and 20% of produce-related outbreaks documented in the United States from 1998 to 2002, respectively. In 2005 and 2006, four multistate outbreaks of salmonellosis associated with eating tomatoes in restaurants sickened at least 450 people in 21 states. In 2006, outbreaks of E. coli O157:H7 infections linked to bagged spinach affected at least 183 people in 26 states and outbreaks associated with consumption of lettuce in fast-food restaurants sickened 81 individuals in three states. In 2008, an outbreak of salmonellosis implicating consumption of jalapeno peppers contaminated with Salmonella Saintpaul involved more than 1,400 infected people in 43 states, the District of Columbia, and Canada. Initially this outbreak was suspected to have been caused by the consumption of contaminated tomatoes, resulting in restaurants and food service operations removing certain types of tomatoes from menus and causing economic losses of approximately 250 million dollars.

Contamination of produce with pathogens can occur during production, harvesting, processing, storage, and handling or during preparation in food service kitchens or at home. Vegetables and fruits such as lettuce, cabbage, tomatoes, lemons, and oranges used to make salads and fresh-squeezed juices or sandwiches in restaurant kitchens often require washing with water before serving. But, this washing step may be ineffective in completely removing all pathogenic microorganisms from produce.

The use of electrolyzed water (EW) in washing produce has been suggested for more effectively removing all pathogenic microorganisms from the produce. EW is produced through electrolysis of a mild salt (NaCl) solution in a chamber with cathode and anode electrodes. Acidic EW (AcEW), generated from the anode side, typically is lethal to most foodborne bacterial pathogens due to its low pH, high oxidation reduction potential, and the presence of hypochlorous acid. Alkaline EW (AkEW), generated from the cathode side, generally has a strong cleaning effect, and it has been used to reduce populations of aerobic bacteria by washing lettuce with AkEW followed by AcEW.

Studies have shown that AcEW can be effective in killing or reducing foodborne pathogens attached to the surface of lettuce, cabbage, spinach, leafy greens, tomatoes, alfalfa sprouts, and green onions. But, most studies examining the efficacy of EW as a produce sanitizer have not considered the unique situations and practices at food service and retail establishments. Further, such studies have failed to consider a cleaning step followed by a sanitizing step or mechanical processing as part of this EW use. Further, despite the use of EW for washing produce, studies have shown an inability to achieve a minimum 5 log colony-forming unit (CFU) reduction of foodborne pathogens per unit of produce.

For example, one study did mimic produce processing in a food service establishment, and the cleaning and sanitizing steps of produce washing at different stages influenced the log reduction of foodborne pathogens on produce. In that study, the efficacy of EW in killing Escherichia coli O157:H7 was examined for iceberg lettuce, cabbage, lemons, and tomatoes by using washing and/or chilling treatments simulating those followed in some food service kitchens. Greatest reduction levels on lettuce were achieved by sequentially washing with 14-A (amperage) AcEW for 15 or 30 seconds followed by chilling in 16-A AcEW for 15 minutes. This procedure reduced the pathogen by 2.8 and 3.0 log CFU per leaf, respectively, whereas washing and chilling with tap water reduced the pathogen by 1.9 and 2.4 log CFU per leaf. Washing cabbage leaves for 15 or 30 seconds with tap water or 14-A AcEW reduced the pathogen by 2.0 and 3.0 log CFU per leaf and 2.5 to 3.0 log CFU per leaf, respectively. The pathogen was reduced by 4.7 log CFU per lemon by washing with 14-A AcEW and 4.1 and 4.5 log CFU per lemon by washing with tap water for 15 or 30 seconds. A reduction of 5.3 log CFU per lemon was achieved by washing with 14-A alkaline EW for 15 seconds prior to washing with 14-A AcEW for 15 seconds. Washing tomatoes with tap water or 14-A AcEW for 15 seconds reduced the pathogen by 6.4 and 7.9 log CFU per tomato, respectively. Application of AcEW using procedures mimicking food service operations should help minimize cross-contamination and reduce the risk of E. coli O157:H7 being present on produce at the time of consumption.

Additionally, the EPA and FDA limit the use of cleaning solutions used to sanitize food to 50-200 ppm free available chlorine. Accordingly, it is necessary to produce a solution that adheres to these limits.

Thus, it would be desirable to develop a retail-applicable, repeatable process, system, and relatively compact washing assembly that consistently and reliably achieved an approximate 5 log CFU reduction of foodborne pathogens per unit of produce for a vast range of produce where each type of produce has a variety of washing tolerances.

### SUMMARY

Briefly described, and according to one embodiment, aspects of the present disclosure generally relate to systems and methods for washing produce to achieve an approximate 5 log colony-forming unit (CFU) reduction of foodborne pathogens per unit of produce. In one embodiment, a method is provided. The method may comprise rinsing a unit of produce and cleaning the unit of produce with a cleaning solution. The method may further comprise sanitizing the unit of produce with a sanitizing solution and drying the unit of produce, wherein the method achieves a predetermined colony-forming unit (CFU) reduction of foodborne pathogens per unit of produce.

According to one embodiment, cleaning may comprise submerging the unit of produce in the cleaning solution. In one embodiment, sanitizing may comprise at least one of draining the cleaning solution, agitating the unit of produce in the sanitizing solution for a predetermined period of time, rotating the unit of produce at a predetermined revolutions per minute (RPM), and draining the sanitizing solution. According to one embodiment, the predetermined period of time is dependent on the produce type. In one embodiment, the produce type is romaine lettuce, and the predetermined period of time is 15 minutes. In one embodiment, the produce type is iceberg lettuce, and the predetermined period of time is 30 minutes. In one embodiment, the produce type is tomatoes, and the predetermined period of time is 10 minutes. In one embodiment, the predetermined RPM is 100 RPM. In one embodiment, a direction of rotation is alternated at predetermined time intervals.

According to one embodiment, the sanitizing solution comprises about 150 ppm free available chlorine. In one embodiment, the cleaning solution and/or the sanitizing solution comprises electrolyzed water (EW).

In one embodiment, an assembly is provided. The assembly may comprise a rinser in fluid communication with a fluid source, wherein the rinser is configured to perform rinsing of a unit of produce; a soaker/agitator in fluid communication with the fluid source, and wherein the soaker/agitator is configured to perform one or more of cleaning and sanitizing the unit of produce; and a dryer in mechanical communication, wherein the dryer is configured to dry the unit of produce. In one embodiment, at least of of the rinsing, cleaning, and sanitizing of the unit of produce is performed using electrolyzed water (EW). In one embodiment, the sanitizing solution comprises about 150 ppm free available chlorine.

According to one embodiment, the assembly further comprises a removable produce container configured for insertion into the soaker/agitator, wherein the removable produce container is configured to receive the unit of produce, and wherein the soaker/agitator is configured to receive the removable produce container. In one embodiment, the removable produce container comprises a plurality of holes sized to allow at least one of fluid and organic matter to drain from the removable produce container.

According to one embodiment, the assembly may be operatively coupled to one or more processors and a memory coupled to the one or more processors and storing instructions that, when executed by the one or more processors, cause the assembly to perform the rinsing, cleaning, sanitizing, and drying of the unit of produce according to a predetermined sequence. In one embodiment, the assembly comprises programmable controls configured for interfacing with the one or more processors and the memory coupled to the one or more processors.

According to one embodiment, the assembly comprises electrolyzing plates, and wherein the electrolyzing plates are configured to generate at least one of a cleaning solution and a sanitizing solution from fluid received into the assembly via the fluid source. In one embodiment, cleaning comprises submerging the unit of produce in a cleaning solution. In one embodiment, sanitizing comprises at least one of draining a cleaning solution, agitating the unit of produce in a sanitizing solution for a predetermined period of time, rotating the unit of produce at a predetermined revolutions per minute (RPM), and draining the sanitizing solution.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a flow chart of an example process for washing produce to achieve an approximate 5 log CFU reduction of foodborne pathogens per unit of produce, according to an example embodiment of the present disclosure.

FIG. 2 is a cross-sectional view of an apparatus for washing produce to achieve an approximate 5 log CFU reduction of foodborne pathogens per unit of produce, according to an example embodiment of the present disclosure.

FIG. 3 illustrates test result data for the log reduction in Salmonella Typhimurium DT 104 in romaine lettuce after undergoing a process for washing produce, according to an example embodiment of the present disclosure.

FIG. 4a illustrates test result data for the log reduction in E. coli O157:H7 in romaine lettuce after undergoing a process for washing produce, according to an example embodiment of the present disclosure.

FIG. 4b illustrates test result data for the log reduction in E. coli O157:H7 in romaine lettuce after undergoing a process for washing produce with 100 RPM, according to an example embodiment of the present disclosure.

FIG. 5a illustrates test result data for the log reduction in Salmonella Typhimurium DT 104 in iceberg lettuce after undergoing a process for washing produce, according to an example embodiment of the present disclosure.

FIG. 5b illustrates test result data for the log reduction in Salmonella Typhimurium DT 104 and E. coli O157:H7 in iceberg lettuce after undergoing a process for washing produce with 100 RPM, according to an example embodiment of the present disclosure.

FIG. 6 illustrates test result data for the log reduction in E. coli O157:H7 in iceberg lettuce after undergoing a process for washing produce, according to an example embodiment of the present disclosure.

FIG. 7 illustrates test result data for the log reduction in Salmonella Typhimurium DT 104 in tomatoes after undergoing a process for washing produce, according to an example embodiment of the present disclosure.

FIG. 8 illustrates test result data for the log reduction in E. coli O157:H7 in tomatoes after undergoing a process for washing produce, according to an example embodiment of the present disclosure.

FIG. 9 is a block diagram of an illustrative computer system architecture, according to an example implementation.

### DETAILED DESCRIPTION

Certain embodiments of the disclosed technology provide systems and methods for washing and sanitizing produce to kill or sufficiently reduce foodborne pathogens. In particular, aspects of the present disclosure relate to a retail-applicable, repeatable process, system, and relatively compact washing/sanitizing assembly that consistently and reliably achieves an approximate 5 log CFU reduction of foodborne pathogens per unit of produce for a vast range of produce where each type of produce has a variety of washing tolerances. In one embodiment of the present disclosure, a retail-applicable, repeatable process, system, and relatively compact washing/sanitizing assembly consistently and reliably achieves a minimum 5 log CFU reduction of foodborne pathogens per unit of produce to meet NSF Protocol P423.

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. It is to be understood, however, that embodiments of the disclosed technology may be practiced without these specific details. In other instances, well-known methods, structures and techniques have not been shown in detail in order not to obscure an understanding of this description. References to “one embodiment,” “an embodiment,” “example embodiment,” “various embodiment,” etc., indicate that the embodiment (s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Also, as used herein, “electrolyzed water,” “EO water,” and/or “EW” may refer to water produced by the electrolysis of ordinary water (e.g., tap water) that contains sufficient levels of dissolved sodium chloride. Typically, electrolysis of ordinary tap water may yield acidic EW (“AcEW”) and alkaline EW (“AkEW”). As used herein, “electrolyzed water” or “EW” may refer to “acidic EW,” “AcEW,” “alkaline EW,” “AkEW,” and/or “AkEW/AcEW,” which may be a mixture of alkaline EW and acidic EW. Further, as used herein, “solution” may refer to an aqueous substance used in the process of cleaning and/or sanitizing produce. Also, as used herein, “solution” may refer to a “cleaning solution” and/or a “sanitizing solution.” Additionally, as used herein, “cleaning solution” may refer to “alkaline EW” or “AkEW” in addition to “electrolyzed water” or “EW.” Finally, as used herein, “sanitizing solution” may refer to “acidic EW” or “AcEW” in addition to “electrolyzed water” or “EW.” Further, “sanitizing solution” may refer to “aqueous sanitizing solution,” “EO Water containing 150 mg/L free chlorine,” and/or “sanitizing solution comprising 150 ppm free available chlorine.”

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the present invention are intended to be illustrative and not restrictive. Many suitable materials that would perform the same or a similar function as the materials described herein are intended to be embraced within the scope of the present invention. Such other materials not described herein can include, but are not limited to, for example, materials that are developed after the time of the development of the present invention.

Example embodiments of the disclosed technology will now be described with reference to the accompanying figures.

As noted, aspects of the present disclosure relate to a retail-applicable, repeatable process, system, and relatively compact washing assembly that consistently and reliably achieves a minimum 5 log CFU reduction of foodborne pathogens per unit of produce to meet NSF Protocol P423. Founded in 1944, NSF International is an independent, not-for-profit organization, dedicated to public health safety and protection of the environment by developing standards, by providing education, and by providing superior third-party conformity assessment services while representing the interest of all stakeholders. NSF International is a leading American National Standards Institute-accredited developer of more than 50 American National Standards that protect public health and the environment.

NSF Protocol P423 was vetted by industry, regulatory, and user experts and then critically reviewed by the NSF Council of Public Health Consultants. It is a protocol for engineered electrochemically activated water systems, which typically include a specially designed reactor and a collection and dispensing vessel, that produce cleaning and sanitizing products through electrically activating tap water or water and salt into ionic compounds containing oxidizers such as oxygen, chlorine, bromine, or iodine, as well as weak (or dilute) ionic reducing agents used for cleaning of oily soils. The systems generally are intended to create cleaning/sanitizing solutions on-site, thereby eliminating the need to purchase, transport, and store cleaning products. The protocol provides the requirements for design and construction to ensure general sanitation and electrical safety of such a system, and it details the labeling and product information requirements, including the necessary information that appears in the operation and instruction manual. Most importantly to customers, the protocol details performance criteria.

The performance criteria are based on Section 4-501.114 of the 2009 FDA Food Code, which mandates that engineered electrochemically activated water systems repeatedly demonstrate and meet specific characteristics of freely available chlorine as specified in the Code. Along with performance specifications, NSF developed a test procedure to evaluate sanitizer production and efficacy. Finally, the protocol lists the acceptance criteria that the device must undergo, including rigorous in situ testing requirements, in order for the device to bear the NSF mark.

As previously noted, aspects of the present disclosure relate to a process, system and assembly that can consistently and reliably achieve an approximate 5 log CFU reduction of foodborne pathogens per unit of produce for a wide variety of produce such as, for example, romaine lettuce, iceberg lettuce, tomatoes, fruits, and other produce that may be utilized in a restaurant environment. According to one aspect, processes, systems, and assemblies of the present disclosure may consistently and reliably achieve a minimum 5 log CFU reduction of foodborne pathogens per unit of produce to meet NSF Protocol P423 for a wide variety of produce.

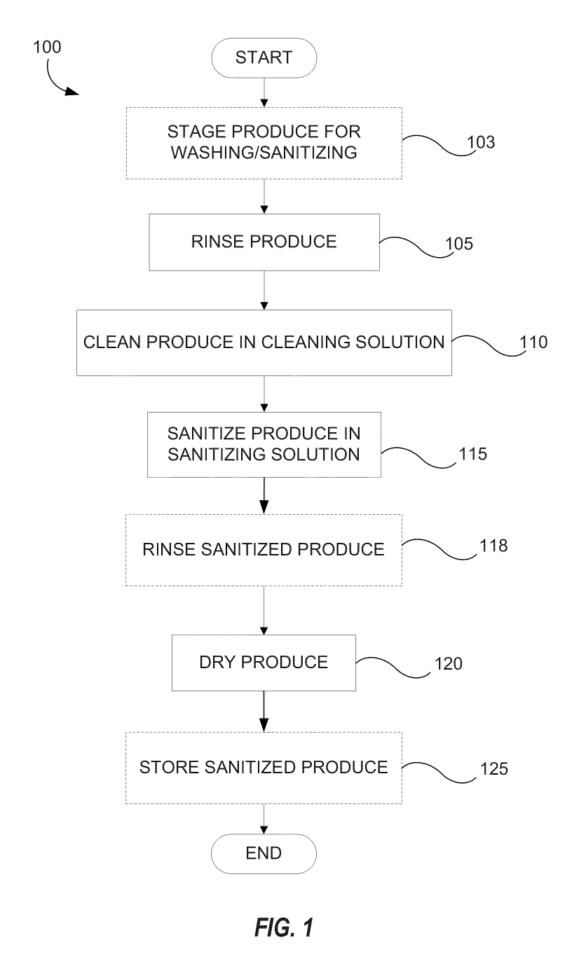

FIG. 1 shows a process 100 for washing/sanitizing produce to achieve an approximate 5 log CFU reduction of foodborne pathogens per unit of produce. As shown in FIG. 1, in one embodiment, the process 100 may comprise an optional staging step 103 in which produce is staged for washing. As used herein, “produce” may refer to a predetermined volume or unit of produce. Further, in one embodiment, the process 100 may comprise a rinsing step, at 105. For example, the rinsing step 105 may comprise rinsing the produce with tap water or other solution (e.g., EW water). In one embodiment, the rinsing step 105 may comprise rinsing the produce for three seconds per leaf or produce item. The process 100 may further comprise cleaning step, at 110. In an example embodiment, the cleaning step 110 may comprise submerging the produce in, for example, a cleaning solution (e.g., AkEW). Likewise, the cleaning step 110 may occur over a predetermined period of time.

Further, as shown in FIG. 1, the process 100 may comprise a sanitizing step, at 115. In one embodiment, the sanitizing step 115 may involve further soaking the produce. For example, in one embodiment, the sanitizing step 115 may comprise draining the cleaning solution used in the cleaning step 110 and submerging and soaking the produce in fresh sanitizing solution (e.g., AcEW). Further, the sanitizing step 115 may comprise agitating the produce, which may occur for a predetermined period of time and a predetermined RPM. Likewise, the sanitizing step 115 may also occur in a sanitizing solution such as a solution comprising 150 ppm free available chlorine. Additionally, in one embodiment, the sanitizing step 115 may involve agitating the produce by spinning/rotating the produce or moving the produce up/down within a vessel, such as a removable produce container, while the produce is submerged in the sanitizing solution. In one embodiment, the rotation may periodically change direction to further agitate the produce. Put differently, the direction of rotation may be alternated at predetermined time intervals. The sanitizing solution may be drained at the end of the sanitizing step 115, according to one embodiment.

In one embodiment, as shown in FIG. 1, the process 100 may comprise an additional, optional rinsing step 118, which may occur for a predetermined time such as, for example, 30 seconds. The optional rinsing step 118 may comprise rinsing the produce with tap water or other solution (e.g., EW water). Additionally, as shown in FIG. 1, the process 100 may comprise a drying step 120. For example, in one embodiment, the drying step 120 may comprise utilizing centrifuge-type device to remove excess cleaning solution from the produce. Finally, in one embodiment, and as shown in FIG. 1, the process 100 may comprise an optional storage step 125 wherein the sanitized produce is stored until it is needed.

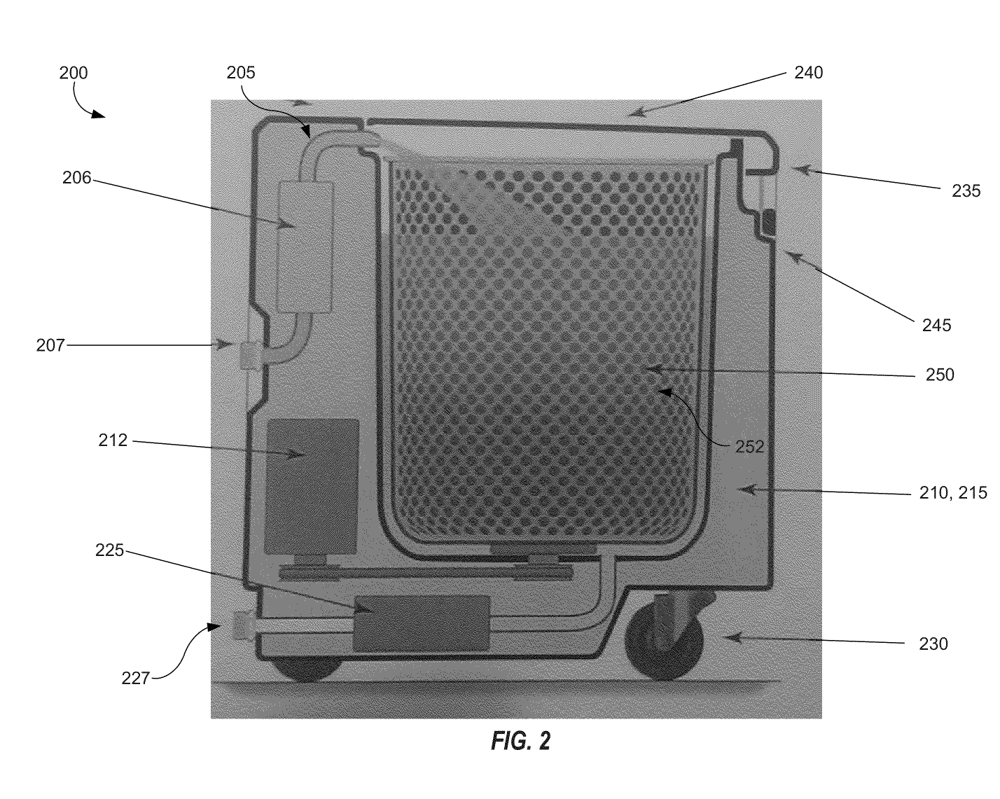

FIG. 2 shows a cross-sectional view of an embodiment of an assembly 200, which may be utilized for washing produce to achieve an approximate 5 log CFU reduction of foodborne pathogens per unit of produce. As shown in FIG. 2, in one embodiment, the assembly 200 may comprise various subassemblies or mechanisms, which may include a rinser 205 that may be used in a rinsing step 105, as described in relation to FIG. 1. The rinser 205 may be coupled to a water inlet 207, which may be in fluid communication with a fluid source external to the assembly 200. The rinser 205 may be configured to rinse produce with ordinary water (e.g., tap water), cleaning solution (e.g., alkaline EW or AkEW), and or sanitizing solution (e.g., AcEW, solution comprising about 150 ppm free available chlorine). The rinser 205 may be further configured with electrolyzing plates 206. In one embodiment, the electrolyzing plates 206 may be used to generate a cleaning solution or sanitizing solution from water such as ordinary tap water received into the assembly 200 from a fluid source via the water inlet 207.

Further, the assembly 200 may comprise a soaker/agitator 210, which may be used in a cleaning step 110 and/or sanitizing step 115, as described. In one embodiment, the soaker/agitator 210 may be configured to receive produce. For example, the soaker/agitator 210 may be basket-shaped such that a volume of produce can be placed inside the soaker/agitator 210. The soaker/agitator 210 may be mechanically coupled to a motor 212, which may be used to drive the soaker/agitator 210. In one embodiment, the assembly 200 may comprise a dryer 215, which may be used in the drying step 120. In one embodiment, both the soaker/agitator 210 and dryer 215 subassemblies may be configured as a single unit, as is shown in FIG. 2. Additionally, according to one embodiment, the assembly 200 may comprise a pump 225 and drain 227. In one embodiment, the drain 227 may be in fluid communication with an external drain. Also, in one embodiment, the assembly 200 may comprise one or more casters 230, which may be used to moving the assembly 200 as is necessary.

Additionally, in one embodiment, the assembly 200 may be configured to receive a removable, perforated produce container 250 that can be sized for various produce volume needs. For example, in one embodiment, the soaker/agitator 210 may be configured to receive the removable produce container 250. Accordingly, produce in either bulk form or chopped form can be stored in the removable container 250 until a need arises to sanitize the produce. When the time comes, the removable produce container 250 can be located into an assembly 200 having a lockable lid 235 that can be secured until a process 100 is completed. In one embodiment, the lockable lid 235 may further comprise a viewing window 240, which may allow a user to observe the progress of a sanitization process 100. Further, in one embodiment, the removable produce container 250 may be configured such that cleaning solution, sanitizing solution, or other fluid can drain from the removable produce container 250 without allowing the produce to egress from the removable produce container. So, for example, the removable produce container 250 may include holes or apertures 252 that are sized to allow fluid and organic matter to escape or drain while keeping the produce inside the removable produce container 250. As will be understood and appreciated, by allowing fluid to drain form the removable produce container 250, organic matter will also be removed from the removable produce container 250 (and the produce that remains inside the removable produce container 250), thus increasing the efficacy of the cleaning solution and sanitizing solution. In other embodiments, the soaker/agitator 210 may be configured to allow fluids and organic matter to drain without allowing the produce to escape without the use of a removable produce container 250.

In one embodiment, the assembly 200 may be configured to perform the cleaning step 110, sanitizing step 115, and drying step 120. In such a configuration, produce may be placed into the removable produce container 250 where the rinsing step 105 can be performed, separate from the assembly 200. After the rinsing step 105, the produce can be stored in the removable produce container 250 until the time comes to complete the remainder of the sanitizing process 100. Accordingly, at an appropriate time, the removable produce container 250 may be located into the assembly 200. In one embodiment, a lockable lid may be secured, and the cleaning step 110 and sanitizing step 115 may be completed for a predetermined time that has been calculated to provide the at least 5 log CFU reduction of foodborne pathogens. Finally, the drying step 120 may be completed.

In one embodiment, the assembly 200 may comprise or be in communication with a general-purpose computer, a special-purpose computer, a processor, or other programmable data processing apparatus. The special-purpose computer may be configured to execute instructions such that, for example, the rinsing step 105, cleaning step 110, sanitizing step 115, and drying step 120 are performed according to a predetermined sequence and for predetermined intervals. The assembly 200 may further comprise programmable controls 245 for interfacing with the special-purpose computer or for controlling aspects of the assembly 200. For example, in one embodiment, the programmable controls 245 may be used to control aspects of the assembly relating to a specific produce type and sanitizing process 100 requirements specific to that produce type (e.g., reduced or increased time for a particular process step, more or less agitation) that will help preserve the quality of the produce while achieving the desired log reduction of foodborne pathogens. In one embodiment, the programmable controls 245 may be used to override or stop a sanitization process 100).

### Study and Results

In one study, the pathogen reduction and quality of fresh produce using only a sanitizing solution and an assembly sharing certain features of assembly 200 using traditional food service operation conditions was tested. A primary focus of the study was to determine the treatment time and agitation speed needed to achieve 5 log reductions of Escherichia coli O157:H7 and Salmonella Typhimurium DT 104 on different produce items using only a sanitizing solution such as AcEW water produced by a Gen-Eon Insta-Flow device.

The study proposal was to test four different types of produce (iceberg lettuce, romaine lettuce, grape tomato and 6×6 round red tomatoes) to determine time and agitation needed to achieve 5 log reduction of E. coli O157:H7 and S. Typhimurium DT 104 using a process similar to process 100 and an assembly such as assembly 200.

### Bacterial Strains:

A mixture of five strains of nalidixic acid adapted E. coli O157:H7 were used in this study. The five strains consisted of CDC-658 (human isolate), E-19 (calf isolates), F-4546 (human isolates), H-1730 (human isolate) and E009 (beef isolate). Five isolates of Salmonella Typhimurium DT 104: strains H2662 (cattle isolate), 11942A (cattle isolate), 13068A (cattle isolate), 152N17-1 (dairy isolate) and H3279 (human isolate) were used in this study. Each strain was grown individually in 10 ml tryptic soy broth supplemented with 50 mg/L nalidixic acid (TSBN) or in TSB for 24 hours at 37° C. At the end of the incubation period, each strain was sedimented by centrifugation (2000×g, for 15 minutes). Cells were resuspended in 2 ml of 0.1% peptone water. Equal volume of each strain suspension was combined to obtain 10 ml of an inoculum containing approximately 9 log CFU/ml. Bacterial population was verified by plating 0.1 ml of appropriate dilution on tryptic soy agar supplemented with 50 mg/L nalidixic acid (TSAN) or on TSA for S. Typhimurium DT 104.

### Preparation of Sanitizing Solution:

The sanitizing solution was generated using a Gen-Eon EO Technologies' Insta-Flow continuous EO water production device and stored in a sealed container at 4° C. for two hours before use. The pH of the cleaning solution was either 6.5 or 7.5. The oxidation/reduction potential (“ORP”) of the cleaning solution was 760±19 mV. The free chlorine concentration of the cleaning solution was 155±3 mg/L.

### Source, Preparation, Inoculation, and Treatments of Produce:

Iceberg lettuce (Lactuca sativa L.), Romaine lettuce (Lactuca sativa L. var. longifolia), grape tomatoes (Solanum lycopersicum), and 6×6 round red tomatoes (Lycopersicum esculentum Mill.) were obtained from a local restaurant, and all produce was stored at 4° C. and used within 24 hours.

### a) Iceberg Lettuce and Romaine Lettuce:

The outer two or three damaged leaves of iceberg lettuce and romaine lettuce were discarded. The next three or four whole leaves were collected and utilized in antimicrobial efficacy determination experiments. Each whole leaf was spot inoculated with 100 μl (15 to 20 drops) E. coli O157:H7 or S. Typhimurium DT104 mixture prepared as described above. The inoculated produce was allowed to dry under laminar flow hood for two hours and then stored at 4° C. for 24 hours to simulate produce handling practices in food service kitchens.

A three-step protocol was used to determine the effectiveness of a sanitizing solution comprising about 150 ppm free available chlorine to reduce pathogens from produce surfaces. In the first step, whole leaves were rinsed under running tap water (ca. 2±0.2 L/minutes) or sanitizing solution for 3 sec/leaf. In the following step, each inoculated leaf was cut into 2-to-3 cm long pieces and 400 g of chopped leaves were submerged in either 1:10 or 1:15 w/v, chilled deionized (DI) sterilized water (control) or cleaning solution (˜150 mg/L available chlorine) (4° C.) in a salad spinner for various lengths of time (1, 5, 10, 15 or 30 minutes) with varying levels of RPMs (i.e., agitation). At the end of designated washing period, treatment solution was drained and replaced with fresh chilled sanitizing solution or deionized sterilized water and produce was further washed for 30 seconds. After draining and spinning to remove excess water, washed leaves were combined with 200 ml of DE broth, whereas a 25 ml sample of treatment solution was combined with 25 ml of dDE for microbiological analysis.

### b) Grape Tomatoes and 6×6 Tomatoes:

Uniform size of grape and 6×6 tomatoes without damage or bruises were selected for the experiment. Tomatoes were spot inoculated with either 100 μl (6×6 tomatoes) or 50 μl (grape tomatoes) of E. coli O157:H7/S. Typhimurium DT104 mixture cell suspension per produce item. The inoculated produce was then allowed to dry under laminar flow hood for two hours and then stored at 4° C. for 24 hours to simulate produce handling practices in food service kitchens.

Tomatoes were washed by rubbing the entire surface with gloved hands under running wash water (sanitizing solution or deionized water) for 3 sec/tomato. After washing, an appropriate amount of tomatoes were submerged in either 1:10 or 1:15 w/v, chilled deionized sterilized water (control) or sanitizing solution (˜150 mg/L available chlorine) (4° C.) in a salad spinner for various lengths of time (1, 5, or 10 minutes) with varying levels of agitation. After treatment, tomatoes were placed in 50 ml DE broth containing 1.5 litter round-bottom Whirl-Pak bags and 25 ml of treatment solution was collected separately and combined with 25 ml of double strength DE broth for microbiological analysis. Each experiment was replicated two times.

### Microbiological Analysis:

The Whirl-Pak bags containing iceberg lettuce, romaine lettuce, samples and DE broth were pummeled in a stomacher for one minute at normal (230 RPM) and high (260 RPM) speed respectively. The 6×6 tomatoes and grape tomatoes in Whirl-Pak bags with DE broth were hand rubbed for two minutes. The DE wash solution was serially diluted in 0.1% peptone water and plated on sorbitol MacConkey agar supplemented with 50 μg/ml nalidixic acid and 0.1% sodium pyruvate (SMACNP) and on TSAN containing 0.1% sodium pyruvate. For S. Typhimurium DT 104 enumeration, XLD agar supplemented with 0.1% sodium pyruvate was used. To detect the presence of low numbers of pathogens that would not be detected by direct platting, 250 ml of double strength modified TSB supplemented with 50 mg/L nalidixic acid and 0.1% sodium pyruvate (dmTSBNP) was added to each stomacher bag containing iceberg lettuce and romaine lettuce with 200 ml of DE broth.

For bags containing tomatoes, 50 ml of DE broth and bags containing 25 ml of wash solutions and 25 ml of dDE, 50 ml of dmTSBNP was added. For S. typhimurium DT 104 enrichment, Rappaport-vassiliadis broth (R-V broth) with dDE broth was used. All enrichments were incubated at 37° C. or 42° C. for 24 hours. Where direct plating did not yield any colonies, enrichment broth was streaked on to SMACNP and SANP or XLDP plates and incubated at 37° C. for 24 hours. At the end of the incubation period plates were examined for the presence of presumptive colonies of the target organism. Five presumptive-positive colonies were randomly selected from SMACNP and XLDN plates and were subjected to biochemical and serological confirmation.

Sanitizing solution after washing treatment was also tested to ensure no bacteria survival after the washing and rinsing treatments.

### Results:

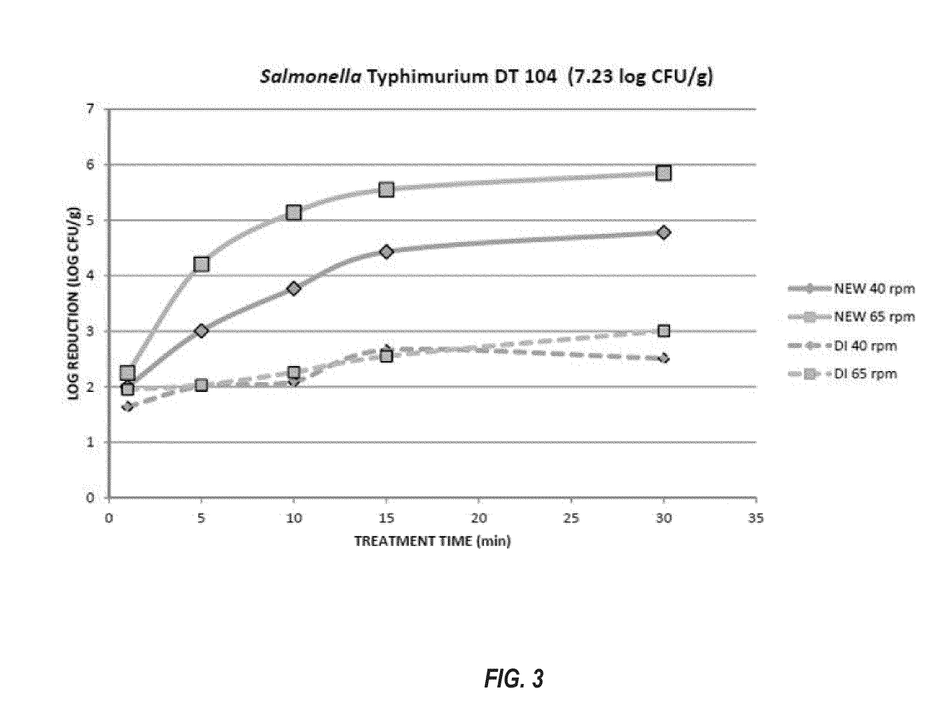

FIG. 3 illustrates test result data for the log reduction in Salmonella Typhimurium DT 104 in romaine lettuce after treatments as described above. As shown in FIG. 3, by using a sanitizing solution (shown in FIGS. 3, 4a, 5a, and 6-8 as “NEW”) having ˜150 mg/L available chlorine for at least 10 minutes at 65 RPM for the sanitizing step 115, a minimum 5 log reduction of Salmonella Typhimurium DT 104 in romaine lettuce was achieved. As further shown in FIG. 3, use of the control solution (i.e., deionized water, shown in FIGS. 3-8 as “DI”) in sanitizing step 115 failed to achieve the desired log reduction of foodborne pathogens.

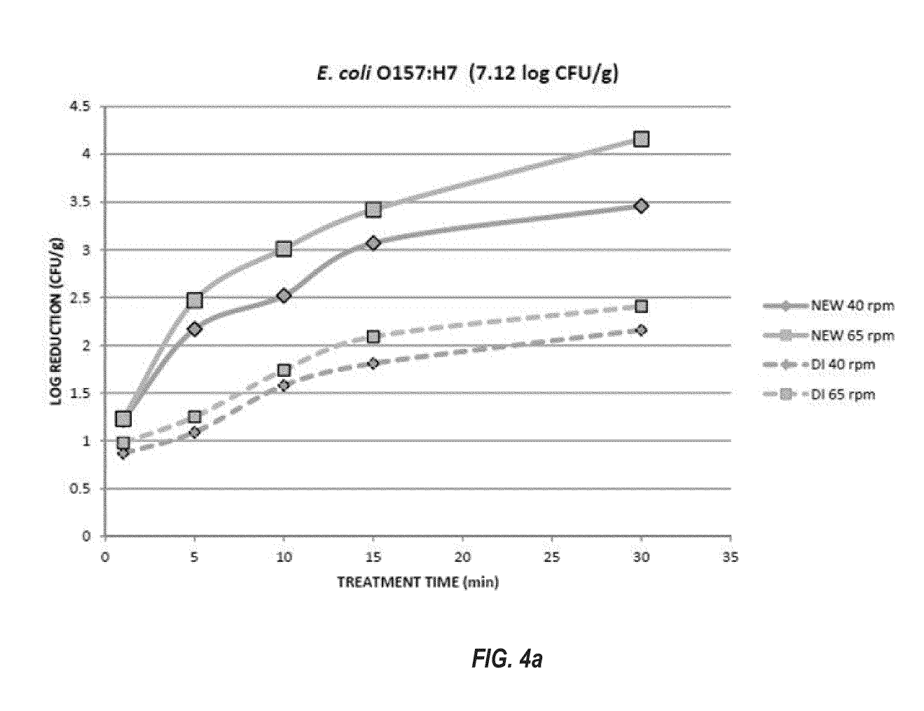

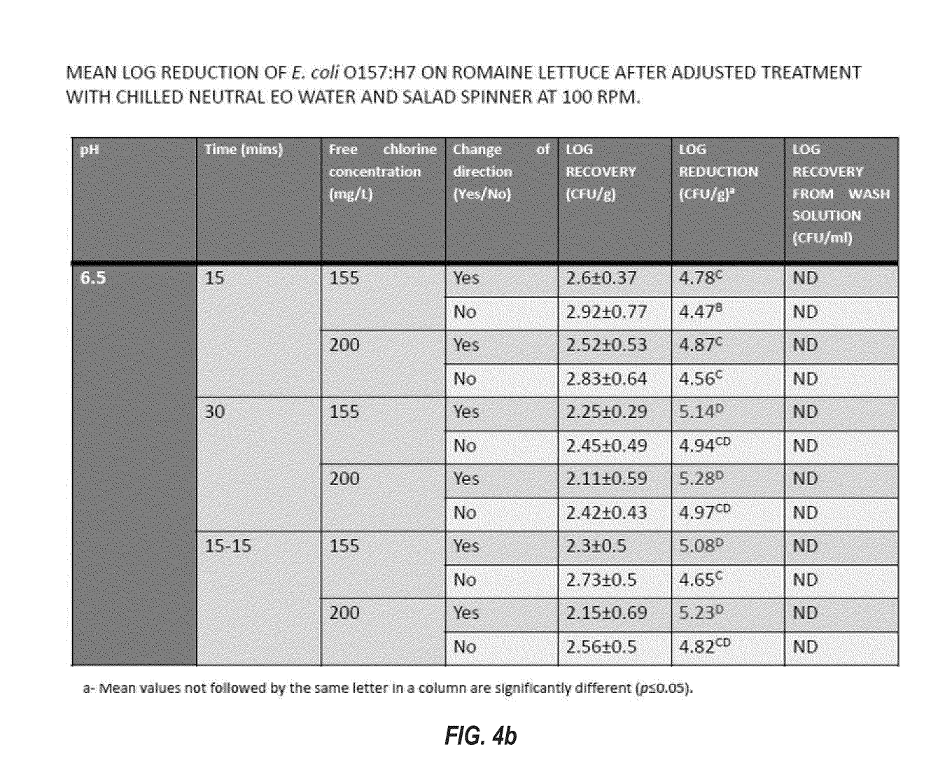

FIG. 4a illustrates test result data for the log reduction in E. coli O157:H7 in romaine lettuce after treatments as described above. As shown in FIG. 4, a near-5 log reduction of E. coli O157:H7 was achieved in the romaine lettuce by using a sanitizing solution having ˜150 mg/L available chlorine for 30 minutes at 65 RPM for the sanitizing step 115. Additionally, as shown in FIG. 4a, use of the control solution in sanitizing step 115 failed to achieve the desired log reduction of foodborne pathogens. As shown in FIG. 4b, when the agitation was increased to 100 RPM while using a sanitizing solution with a lower pH (i.e., pH of 6.5), a 5 log reduction of E. coli O157:H7 was achieved in the romaine lettuce. As will be understood and appreciated, increased agitation is significant in increasing the log reduction.

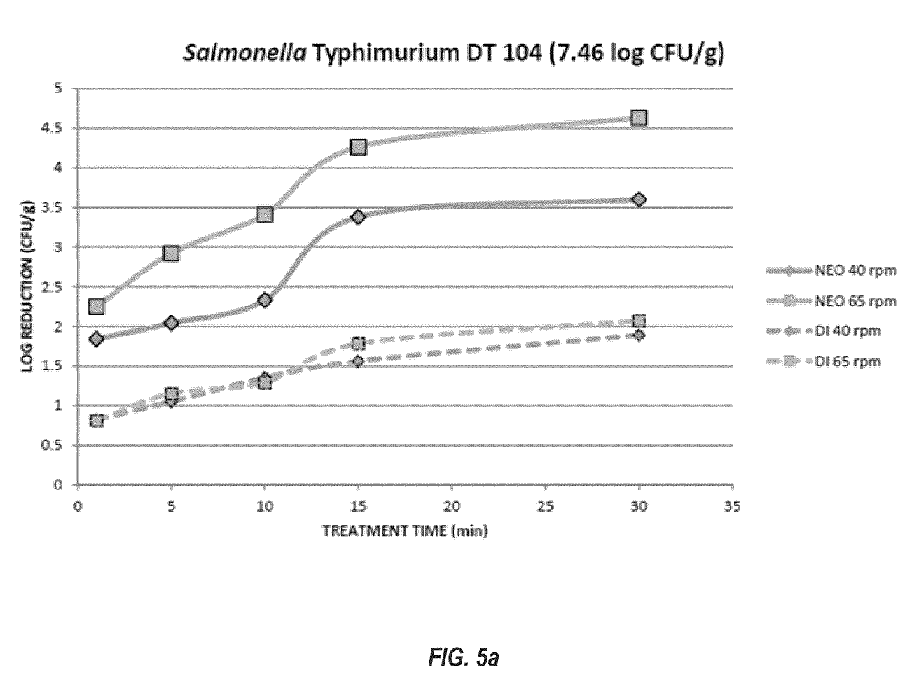

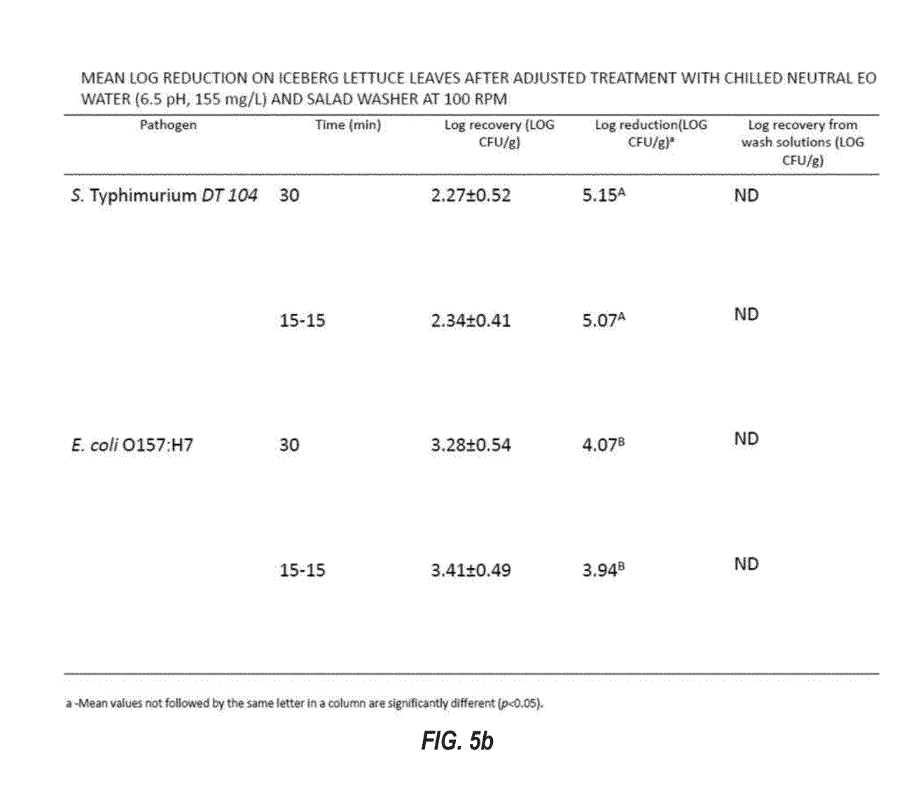

FIG. 5a illustrates test result data for the log reduction in Salmonella Typhimurium DT 104 in iceberg lettuce after treatments as described above. As shown in FIG. 5, use of a sanitizing solution having ˜150 mg/L available chlorine for 30 minutes at 65 RPM for the sanitizing step 115 resulted in a near-5 log reduction of Salmonella Typhimurium DT 104 in the iceberg lettuce. Likewise, as is shown in FIG. 5a, use of a control solution failed to achieve the desired log reduction of foodborne pathogens. Further, as shown in FIG. 5b, when the agitation was increased to 100 RPM while using a sanitizing solution having a pH of 6.5, a 5 log reduction of Salmonella Typhimurium DT 104 in the iceberg lettuce. As with the results shown in FIG. 4b, increased agitation is significant in achieving an increased log reduction.

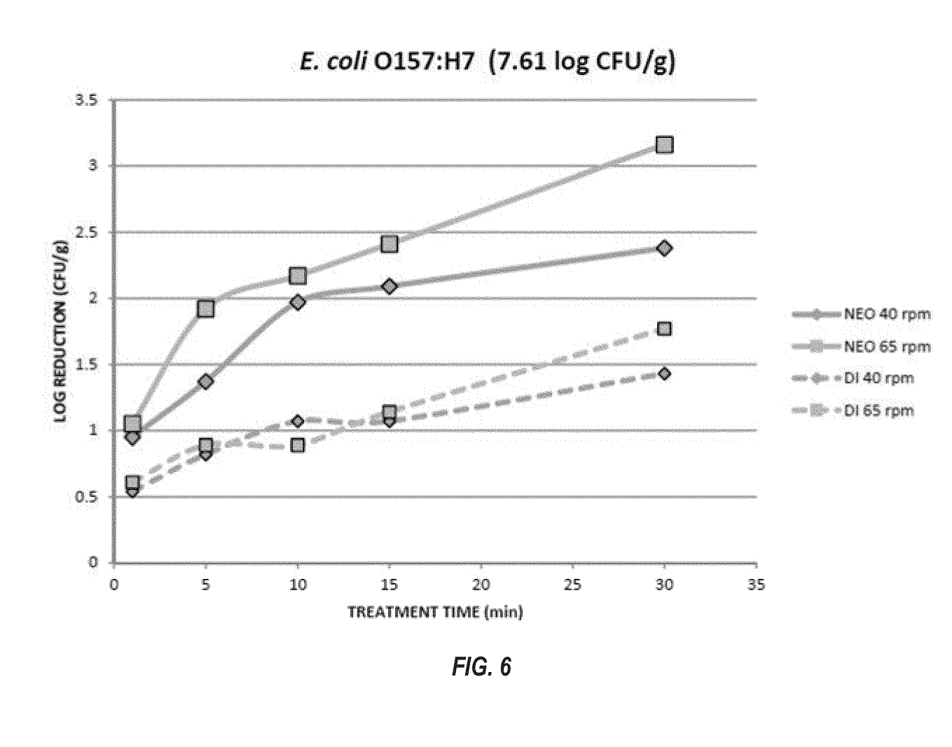

FIG. 6 illustrates test result data for the log reduction in E. coli O157:H7 in iceberg lettuce after treatments as described above. As FIG. 6 illustrates, increased log reduction of E. coli O157:H7 was achieved in the iceberg lettuce after using a sanitizing solution having ˜150 mg/L available chlorine for 30 minutes at 65 RPM for the sanitizing step 115. Further, as shown in FIG. 6, use of a control solution failed to achieve the desired log reduction of foodborne pathogens. Additionally, as discussed above and as further shown in FIG. 5b, when the agitation was increased to 100 RPM while using a sanitizing solution having a pH of 6.5, a 5 log reduction of E. coli O157:H7 was achieved in the iceberg lettuce. Again, increased agitation is shown to be significant in achieving an increased log reduction.

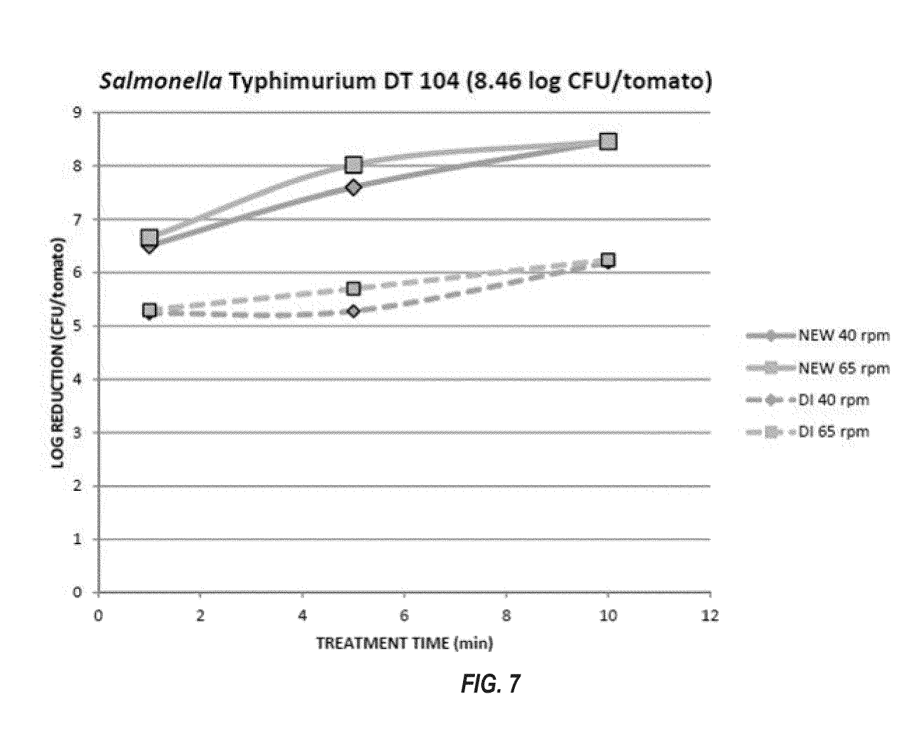

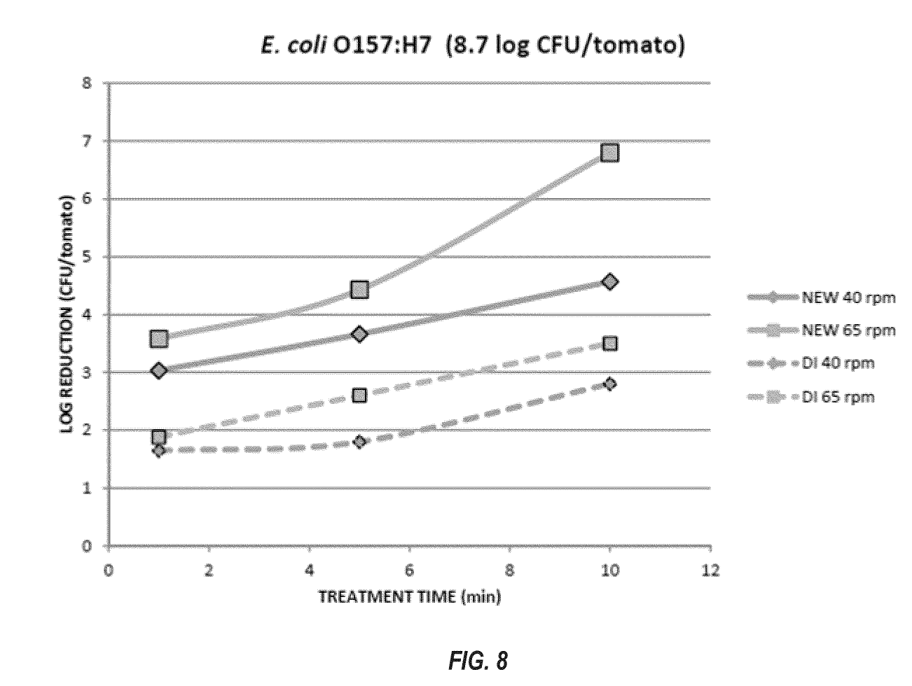

FIG. 7 illustrates test result data for the log reduction in Salmonella Typhimurium DT 104 in tomatoes after treatments as described above. As shown in FIG. 7, a significant log reduction in Salmonella Typhimurium DT 104 was achieved in the tomatoes after using a cleaning solution having ˜150 mg/L available chlorine. The log reduction of foodborne pathogens was achieved after only one minute at both 40 and 65 RPM. Likewise, FIG. 8 illustrates test result data for the log reduction in E. coli O157:H7 in tomatoes after treatments as described above. As with the log reduction of Salmonella Typhimurium DT 104, as shown in FIG. 7, a significant log reduction of E. coli O157:H7 was achieved in the tomatoes by using a cleaning solution having ˜150 mg/L available chlorine for, in particular, ten minutes.

Certain embodiments of the disclosed technology are described above with reference to block and flow diagrams of systems and methods and/or computer program products according to example embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

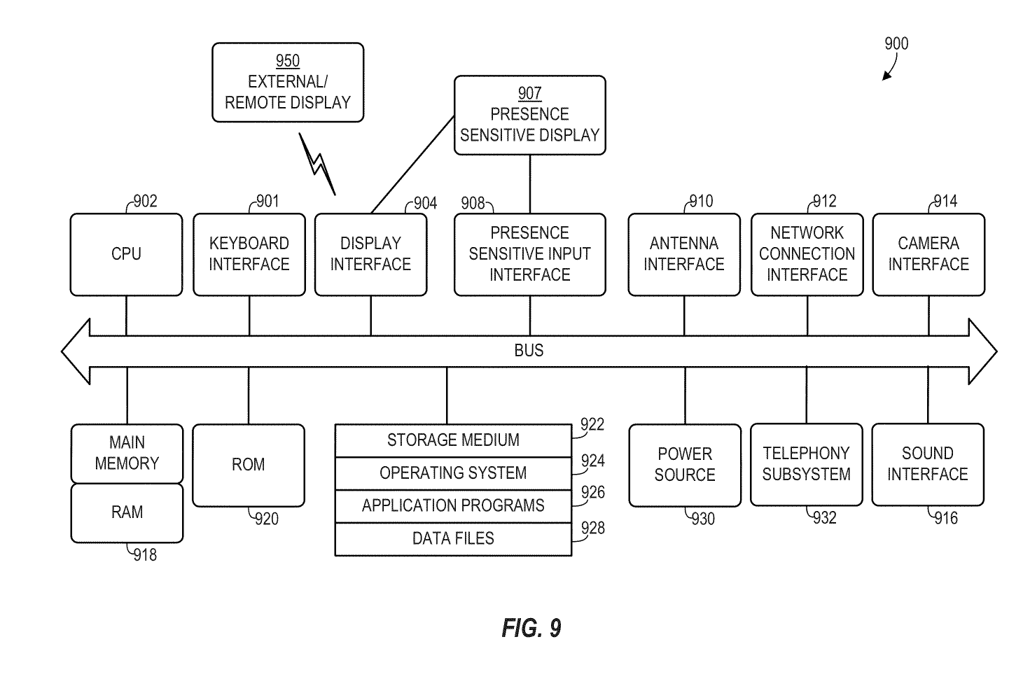

As desired, implementations of the disclosed technology may include a computing device with more or less of the components illustrated in FIG. 9. It will be understood that the computing device architecture 900 is provided for example purposes only and does not limit the scope of the various implementations of the present disclosed systems, methods, and computer-readable mediums.

The computing device architecture 900 of FIG. 9 includes a central processing unit (CPU) 902, where computer instructions are processed; a display interface 904 that acts as a communication interface and provides functions for rendering video, graphics, images, and texts on the display. In certain example implementations of the disclosed technology, the display interface 904 may be directly connected to a local display, such as a touch-screen display associated with a mobile computing device. In another example implementation, the display interface 904 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 904 may wirelessly communicate, for example, via a Wi-Fi channel or other available network connection interface 912 to the external/remote display.

In an example implementation, the network connection interface 912 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 904 may be operatively coupled to a local display, such as a touch-screen display associated with a mobile device. In another example, the display interface 904 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 904 may wirelessly communicate, for example, via the network connection interface 912 such as a Wi-Fi transceiver to the external/remote display.

The computing device architecture 900 may include a keyboard interface 906 that provides a communication interface to a keyboard. In one example implementation, the computing device architecture 900 may include a presence-sensitive display interface 908 for connecting to a presence-sensitive display 907. According to certain example implementations of the disclosed technology, the presence-sensitive display interface 908 may provide a communication interface to various devices such as a pointing device, a touch screen, a depth camera, etc. which may or may not be associated with a display.

The computing device architecture 900 may be configured to use an input device via one or more of input/output interfaces (for example, the keyboard interface 906, the display interface 904, the presence sensitive display interface 908, network connection interface 912, camera interface 914, sound interface 916, etc.,) to allow a user to capture information into the computing device architecture 900. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, Bluetooth-connected device, and the like. Additionally, the input device may be integrated with the computing device architecture 900 or may be a separate device. For example, the input device may be an accelerometer, a magnetometer, a digital camera, a microphone, and an optical sensor.

Example implementations of the computing device architecture 900 may include an antenna interface 910 that provides a communication interface to an antenna; a network connection interface 912 that provides a communication interface to a network. As mentioned above, the display interface 904 may be in communication with the network connection interface 912, for example, to provide information for display on a remote display that is not directly connected or attached to the system. In certain implementations, a camera interface 914 is provided that acts as a communication interface and provides functions for capturing digital images from a camera. In certain implementations, a sound interface 916 is provided as a communication interface for converting sound into electrical signals using a microphone and for converting electrical signals into sound using a speaker. According to example implementations, a random access memory (RAM) 918 is provided, where computer instructions and data may be stored in a volatile memory device for processing by the CPU 902.

According to an example implementation, the computing device architecture 900 includes a read-only memory (ROM) 920 where invariant low-level system code or data for basic system functions such as basic input and output (I/O), startup, or reception of keystrokes from a keyboard are stored in a non-volatile memory device. According to an example implementation, the computing device architecture 900 includes a storage medium 922 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 924, application programs 926 (including, for example, a web browser application, a widget or gadget engine, and or other applications, as necessary) and data files 928 are stored. According to an example implementation, the computing device architecture 900 includes a power source 930 that provides an appropriate alternating current (AC) or direct current (DC) to power components.

According to an example implementation, the computing device architecture 900 includes a telephony subsystem 932 that allows the device 900 to transmit and receive sound over a telephone network. The constituent devices and the CPU 902 communicate with each other over a bus 934.

According to an example implementation, the CPU 902 has appropriate structure to be a computer processor. In one arrangement, the CPU 902 may include more than one processing unit. The RAM 918 interfaces with the computer bus 934 to provide quick RAM storage to the CPU 902 during the execution of software programs such as the operating system application programs, and device drivers. More specifically, the CPU 902 loads computer-executable process steps from the storage medium 922 or other media into a field of the RAM 918 in order to execute software programs. Data may be stored in the RAM 918, where the data may be accessed by the computer CPU 902 during execution. In one example configuration, the device architecture 900 includes at least 128 MB of RAM, and 256 MB of flash memory.

The storage medium 922 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 922, which may comprise a machine-readable storage medium.

According to one example implementation, the term computing device, as used herein, may be a CPU, or conceptualized as a CPU (for example, the CPU 902 of FIG. 9). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or wearable computer. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person of ordinary skill to practice certain embodiments of the disclosed technology, including making and using any devices or systems and performing any incorporated methods. The patentable scope of certain embodiments of the disclosed technology is defined in the claims, and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

What is claimed is:

1. A method comprising:
rinsing a unit of produce;
cleaning the unit of produce with a cleaning solution;
sanitizing the unit of produce with a sanitizing solution; and
drying the unit of produce,
wherein the method achieves a predetermined colony-forming unit (CFU) reduction of foodborne pathogens per unit of produce.

2. The method of claim 1, wherein cleaning comprises submerging the unit of produce in the cleaning solution.

3. The method of claim 1, wherein sanitizing comprises at least one of draining the cleaning solution, agitating the unit of produce in the sanitizing solution for a predetermined period of time, rotating the unit of produce at a predetermined revolutions per minute (RPM), and draining the sanitizing solution.

4. The method of claim 3, wherein the predetermined period of time is dependent on the produce type.

5. The method of claim 4, wherein the produce type of the unit of produce is romaine lettuce, and wherein the predetermined period of time is 15 minutes.

6. The method of claim 4, wherein the produce type of the unit of produce is iceberg lettuce, and wherein the predetermined period of time is 30 minutes.

7. The method of claim 4, wherein the produce type of the unit of produce is tomatoes, and wherein the predetermined period of time is 10 minutes.

8. The method of claim 3, wherein the predetermined RPM is 100 RPM.

9. The method of claim 3, wherein a direction of rotation is alternated at predetermined time intervals.

10. The method of claim 1, wherein the sanitizing solution comprises about 150 ppm free available chlorine.

11. The method of claim 1, wherein the cleaning solution and/or the sanitizing solution comprises electrolyzed water (EW).

12. An assembly comprising:
a rinser in fluid communication with a fluid source, wherein the rinser is configured to perform rinsing of a unit of produce;
a soaker/agitator in fluid communication with the fluid source, and wherein the soaker/agitator is configured to perform one or more of cleaning and sanitizing the unit of produce; and
a dryer in mechanical communication, wherein the dryer is configured to dry the unit of produce.

13. The assembly of claim 12, wherein at least one of the rinsing, cleaning, and sanitizing of the unit of produce is performed using electrolyzed water (EW).

14. The assembly of claim 13, wherein the sanitizing solution comprises about 150 ppm free available chlorine.

15. The assembly of claim 12, further comprising:
a removable produce container configured for insertion into the soaker/agitator, wherein the removable produce container is configured to receive the unit of produce, and wherein the soaker/agitator is configured to receive the removable produce container.

16. The assembly of claim 15, wherein the removable produce container comprises a plurality of holes sized to allow at least one of fluid and organic matter to drain from the removable produce container.

17. The assembly of claim 12, wherein the assembly is operatively coupled to one or more processors and a memory coupled to the one or more processors and storing instructions that, when executed by the one or more processors, cause the assembly to perform the rinsing, cleaning, sanitizing, and drying of the unit of produce according to a predetermined sequence.

18. The assembly of claim 17, further comprising programmable controls configured for interfacing with the one or more processors and the memory coupled to the one or more processors.

19. The assembly of claim 12, wherein the rinser further comprises electrolyzing plates, and wherein the electrolyzing plates are configured to generate at least one of a cleaning solution and a sanitizing solution from fluid received into the assembly via the fluid source.

20. The assembly of claim 12, wherein cleaning comprises submerging the unit of produce in a cleaning solution.

21. The assembly of claim 12, wherein sanitizing comprises at least one of draining a cleaning solution, agitating the unit of produce in a sanitizing solution for a predetermined period of time, rotating the unit of produce at a predetermined revolutions per minute (RPM), and draining the sanitizing solution.
